(19) United States
(12) Patent Application Publication
(10) Pub. No.: US 2016/0379164 A1
(43) Pub. Date: Dec. 29, 2016

(54) METHOD, TERMINAL AND SERVER FOR AUTOMATICALLY PUSHING DELIVERY INFORMATION AND PROVIDING COLLECTION INFORMATION

(71) Applicant: Alibaba Group Holding Limited, Grand Cayman (KY)

(72) Inventor: Jingwei Li, Hangzhou (CN)

(21) Appl. No.: 15/166,781

(22) Filed: May 27, 2016

(30) Foreign Application Priority Data
Jun. 23, 2015 (CN) 201510351235

(51) Int. Cl. G06Q 10/08; H04W 4/02; H04L 29/08

(52) U.S. Cl. CPC G06Q 10/0833; H04L 67/26; H04W 4/021; H04L 67/18; H04W 4/023

(57) ABSTRACT

Provided is a method, terminal and server for automatically pushing delivery information and a method, terminal and server for providing collection information, wherein the method for automatically pushing delivery information includes: obtaining a courier's current geographical position and a delivery destination; determining whether the delivery destination is within a geo-fencing centering about the courier's current geographical position; and pushing the delivery information to the delivery target customer if the delivery destination is within the geo-fencing centering about the courier's current geographical position. The present application determines whether to automatically push the delivery information to the target customer based on the geo-fencing centering about a courier's current geographical position, by which the delivery target customer is promptly informed of relevant information regarding items prior to receiving the items and thus facilitating more timely communication with the courier on item delivery, and increasing efficiency of items delivery.

### CROSS REFERENCE TO RELATED APPLICATION

This application claims the benefit of Chinese Patent Application No. 201510351235, entitled “Method, Terminal And Server for Automatically Pushing Delivery Information And Providing Collection Information”, filed Jun. 23, 2015, which is hereby incorporated by reference herein in its entirety.

### FIELD OF THE DISCLOSURE

The application relates to the field of logistics information, and in particular to a method, terminal and server for automatically pushing delivery information and providing collection information.

### BACKGROUND

In traditional item distribution, the event of sending a distribution notification to a target customer mainly depends on the personal action of a courier. Some couriers are accustomed to directly going to the delivery destination without notifying the target customer in advance. This can easily result in a delivery failure due to the fact that the target customer is not at the delivery destination. Some couriers are accustomed to notifying the target customer, in advance, from the courier's location, which can be a location that is very far from the delivery destination, of a time in the future for the customer to pick up the items. However, the target customer does not know the whereabouts of the courier or how near the courier is to the delivery destination. In addition, the target customer may need to leave the premises for some reason before the arrival of the courier. Further communications between the courier and the customer are needed in order for the customer to determine the current distance of the courier from the delivery destination. Re-confirmation may also be needed as to whether it is still possible to pick up the items. This not only increases the communication cost for logistics distribution but also affects delivery efficiency.

In traditional item collection, the event of receiving a collection request from a sender with items to be collected also depends on the personal action of the courier. In general, the sender actively contacts a courier of a specified company or designates a courier for the collection. Chances are that the courier is located very far from the items' sender, and the courier needs to rush to the collection site to collect the items. This clearly affects the collection efficiency and increases the time and transportation costs of the courier.

### SUMMARY

The present disclosure seeks to address failings in the art and to increase efficiency of item delivery or collection.

According to one embodiment of the application, a method is provided for automatically pushing delivery information. The method comprising obtaining, by a computing device, a courier's current geographical position and a delivery destination; determining, by the computing device, whether the delivery destination is within a geo-fencing centered around the courier's current geographical position; and pushing, by the computing device, delivery information to a delivery target customer if the delivery destination is within the geo-fencing centered around the courier's current geographical position.

Using a geo-fencing centered around a courier's current geographical position, in accordance with at least one embodiment of the present disclosure, a method determines whether to automatically push delivery information to a target customer. The delivery information can include a geographical region of the items to be delivered, when the items to be delivered probably are to arrive, a contact number of the courier, order number of items to be delivered and/or detailed item information. The target customer can be promptly informed of relevant courier information and/or items to be delivered prior to receiving the delivered items. The target customer can flexibly arrange their activity using the received information about the delivery and courier. Additionally, communication with the courier regarding item delivery is improved and the efficiency of item delivery is increased.

According to another embodiment of the application, a method to automatically provide collection information is provided. The method comprising obtaining, by a computing device, a current geographical position of an item to be collected and a current geographical position of each courier of a plurality of couriers; determining, by the computing device and for each courier of the plurality, a geo-fencing centered around the courier's current geographical position; determining, by the computing device, whether the current geographical position of the item to be collected is within at least one courier's determined geo-fencing; and if the current geographical position of the item to be collected is within the at least one courier's determined geo-fencing centered around at least one courier of the plurality of couriers, providing, by the computing device, a sender of the item to be collected with an informational list of the at least one courier, the informational list comprising the current geographical position of each of the at least one courier.

Using a geo-fencing centered around a courier's current geographical position, in accordance with at least one embodiment of the present disclosure, a method determines whether to provide a sender of an item to be collected by a courier with an informational list of at least one courier, which enables the sender to send an item more quickly by using a nearby courier. Item pickup efficiency is significantly increased.

According to another embodiment of the application, a method for managing courier information is provided. The method comprising automatically uploading, by a computing device, a courier's current geographical position; receiving, by the computing device and from a sender of an item to be collected, information regarding the item to be collected in a case that the sender is at a location within a geo-fencing centered around the courier's current geographical position; receiving, by the computing device and from a delivery target customer, information comprising feedback indicating whether delivery is acceptable by the delivery target customer in a case that the delivery target customer's delivery destination is within the geo-fencing centered around the courier's current geographical position; and displaying, by the computing device, received information comprising at least one of the received information regarding the item to be collected and the information comprising feedback indicating whether delivery is acceptable.

In accordance with at least one embodiment, a method automatically uploads a courier's current geographical position and receives feedback from a delivery target customer indicating whether the delivery is acceptable by the deliver target customer and/or receives information regarding an item to be collected from a sender of the item to be collected based on the geo-fencing determined using a courier's current geographical position. The courier can be promptly informed of the relevant information regarding items to be delivered to a nearby target customer or an item sender. Thus, prompt delivery and/or collection service can be provided to target customer and/or item sender. Item delivery and collection efficiency is increased.

According to another embodiment of the application, a method for managing user information is provided. The method comprising uploading, by a user computing device, a current geographic position of an item to be collected; receiving, by the computing device, delivery information in case that an item is to be delivered to the user and the user's position is within a geo-fencing centered around a current geographical position of a courier delivering the item to the user; receiving, by the computing device, an informational list of at least one courier of a plurality of couriers in a case that the user has an item to be collected and the user's position is within the geo-fencing of the at least one courier, the informational list includes the geographical position of each of the at least one courier; and displaying, by the user computing device, at least one of the received delivery information and the received informational list.

In accordance with at least one embodiment, a method automatically uploads the current geographical position of items to be collected and receives delivery information and/or an informational list of at least one courier based on the geo-fencing determined using a courier's current geographical position. A customer is able to be promptly informed regarding an item to be delivered and/or a courier that is to pick up an item to be sent. The customer is able to flexibly arrange an item deliver and/or an item pickup, and to further facilitate item receipt and sending.

According to another embodiment of the application, a server for automatically pushing delivery information is provided. The server comprising a first acquiring unit obtaining a courier's current geographical position and a delivery destination; a first determining unit determining whether the delivery destination is within a geo-fencing centered around the courier's current geographical position; and a first pushing unit pushing delivery information to a delivery target customer if the delivery destination is within the geo-fencing centered around the courier's current geographical position.

Using a geo-fencing centered around a courier's current geographical position, in accordance with at least one embodiment of the present disclosure, a server computer determines whether to automatically push delivery information to a target customer. The delivery information can include a geographical region of the items to be delivered, when the items to be delivered probably are to arrive, a contact number of the courier, order number of items to be delivered and/or detailed item information. The target customer can be promptly informed of relevant courier information and/or items to be delivered prior to receiving the delivered items. The target customer can flexibly arrange their activity using the received information about the delivery and courier. Additionally, communication with the courier regarding item delivery is improved and the efficiency of item delivery is increased.

According to another embodiment of the application, a server to automatically provide collection information is provided. The server comprising a second acquiring unit obtaining a current geographical position of an item to be collected and a current geographical position of each courier of a plurality of couriers; a second determining unit determining, for each courier of the plurality, whether the current geographical position of the item to be collected is within at least one courier's geo-fencing, each courier's geo-fencing being centered around the courier's current geographical position; and an information provision unit providing a sender of the item to be collected with an informational list of at least one courier if the current geographical position of the item to be collected is within the at least one courier's geo-fencing, the informational list comprising the current geographical position of each of the at least one courier.

Using a geo-fencing centered around a courier's current geographical position, in accordance with at least one embodiment of the present disclosure, a server determines whether to provide a sender of an item to be collected by a courier with an informational list of at least one courier, which enables the sender to send an item more quickly by using a nearby courier. Item pickup efficiency is significantly increased.

According to another embodiment of the application, a terminal for managing courier information is provided. The terminal comprising a first position uploading unit automatically uploading a courier's current geographical position; a first information receiving unit receiving, from a sender of an item to be collected, information regarding the item to be collected in a case that the sender is at a location within a geo-fencing centered around the courier's current geographical position; the first information receiving unit receiving, from a delivery target customer, information comprising feedback indicating whether delivery is acceptable by the delivery target customer in a case that the delivery target customer's delivery destination is within the geo-fencing centered around the courier's current geographical position; and a first displaying unit displaying received information comprising at least one of the received information regarding the item to be collected and the information comprising feedback indicating whether delivery is acceptable.

In accordance with at least one embodiment, a courier's terminal automatically uploads a courier's current geographical position and receives feedback from a delivery target customer indicating whether the delivery is acceptable by the deliver target customer and/or receives information regarding an item to be collected from a sender of the item to be collected based on the geo-fencing determined for a courier using the courier's current geographical position. The courier can be promptly informed of the relevant information regarding items to be delivered to a nearby target customer or an item sender. Thus, prompt delivery and/or collection service can be provided to target customer and/or item sender. Item delivery and collection efficiency is increased.

According to another embodiment of the application, a terminal for managing user information is provided. The terminal comprising a second position uploading unit uploading a current geographic position of an item to be collected; a second information receiving unit receiving delivery information in case that an item is to be delivered to the user and the user's position is within a geo-fencing centered around a current geographical position of a courier delivering the item to the user; the second information receiving unit receiving an informational list of at least one courier of a plurality of couriers in a case that the user has an item to be collected and the user's position is within the geo-fencing of the at least one courier, the informational list includes the geographical position of each of the at least one courier; and a second displaying unit displaying at least one of the received delivery information and the received informational list.

In accordance with at least one embodiment, a customer's terminal automatically uploads the current geographical position of items to be collected and receives delivery information and/or an informational list of at least one courier based on the geo-fencing determined using a courier's current geographical position. A customer is able to be promptly informed regarding an item to be delivered and/or a courier that is to pick up an item to be sent. The customer is able to flexibly arrange an item deliver and/or an item pickup, and to further facilitate item receipt and sending.

### BRIEF DESCRIPTION OF THE DRAWINGS

The application is described in detail by embodiments, which are not intended to limit the application with reference to the Drawings hereinafter, from which other characteristics, objectives and advantages of the application will be more evident:

FIG. 1 is a flow diagram of method 1 for automatically pushing delivery information in accordance with one embodiment of the application;

FIG. 2 illustrates the geo-fencing displayed on a map interface with current geographical position of every courier as its center;

FIG. 3 is a flow diagram of method 1 for automatically pushing delivery information in accordance with another embodiment of the application;

FIG. 4 is a flow diagram of method 2 to automatically provide collection information in accordance with one embodiment of the application;

FIG. 5 is a flow diagram of method 2 to automatically provide collection information in accordance with another embodiment of the application;

FIG. 6 is a flow diagram of method 3 for managing courier information in accordance with one embodiment of the application;

FIG. 7 is a flow diagram of method 4 for managing user information in accordance with one embodiment of the application;

FIG. 8 is a schematic block diagram of the server for automatically pushing delivery information in accordance with one embodiment of the application;

FIG. 9 is a schematic block diagram of the server to automatically provide collection information in accordance with one embodiment of the application;

FIG. 10 is a schematic block diagram of the server to automatically provide collection information in accordance with another embodiment of the application;

FIG. 11 is a schematic block diagram of the server to automatically provide collection information in accordance with further embodiment of the application;

FIG. 12 is a schematic block diagram of the terminal for managing courier information in accordance with one embodiment of the application;

FIG. 13 is a schematic block diagram of the terminal for managing user information in accordance with one embodiment of the application;

The same or similar symbols in the Drawings represent the same or similar parts.

### DETAILED DESCRIPTION

The application is described in more details in combination with the Drawings.

Prior to discussing the exemplary embodiments in further details, it should be understood that some exemplary embodiments are described as a process or method as shown in the flow diagrams. The flow diagrams break each operation into sequential processes; however, a number of operations can be undertaken concurrently or simultaneously. Moreover, the sequence of each operation can be re-arranged. When the operation herein is completed, the process can terminate; however, there may be some additional steps not included in the Drawings. The processes herein can be implemented as a method, function, procedure, subroutine, subprogram, etc.

The “computer device” in this context also can be called a “computer”, referring to the intelligent electronic device which undertakes preset processes including numerical calculation and/or logical calculation by running a preset program or instruction set. The device comprising a processor and memory, wherein the processor executes the commands pre-stored in the memory to undertake the preset process, or hardware such as ASIC, FPGA and DSP can execute the commands, or a combination of the two can be used to complete the preset process(s). Examples of a computer device include, but are not limited to, a server, personal computer (PC), notebook PC, tablet computer, smart phone, etc.

Examples of a computer device include a user device and a network device. Examples of a user device include, but are not limited to, a computer, smart phone, PDA, etc. Examples of a network device include, but are not limited to, a single network server, a plurality of network servers, or a cloud consisting of a plurality of computers or network servers configured to provide cloud computing, wherein cloud computing is a type of distributed computing, a super virtual computer consisting of a group of loosely coupled computer set. The application can be implemented using a computer device, but can also be connected to a network to implement the application by interactive operation with other computer devices on the network. Examples of a network to which a computer device is connected include, but are not limited to, Internet, WAN, MAN, LAN, VPN, etc.

It should be understood that the user devices, network devices and networks are exemplary and other devices and networks now known or later developed are also within the scope of the application and comprised herein by way of reference.

Methods discussed hereinafter (wherein some methods are shown by flow diagrams) can be implemented by hardware, software, firmware, middleware, microcode, hardware description language or any combination thereof. In case of implementation by way of software, firmware, middleware or microcode, program code used to execute some tasks or code segments can be stored in readable media (e.g. storage medium) of a machine or computer. The tasks can be executed by (one or more) processors.

Specific structural and functional details disclosed herein are only representative, and are intended to illustrate exemplary embodiments of the application. However, the application can be specifically utilized by alternative configurations of the application, and the application is not to be construed as being limited to the embodiments described herein.

It should be understood that although the terms such as “first” and “second” may be used herein to describe each unit, these units shall not be limited to these terms. These terms are only used to distinguish one unit from another. For example, without departing from the principle of the exemplary embodiments, the first unit can be called the second unit, and similarly the second unit can be called the first unit. Moreover, the term “and/or” used herein includes any combination or all the possible combinations of one or more associated listed items.

It should be understood: when a unit is “connected” or “coupled” to another unit, the unit can be directly connected or coupled to the other unit, or indirectly connected or coupled via some intermediate unit. In contrast, when a unit is “directly connected” or “directly coupled” to another unit, there is no intermediate unit. Other words and expressions used to describe interrelationships of can be illustrated in a similar way (e.g. “between . . . ” in comparison with “directly between . . . ”, “adjacent to . . . ” in comparison with “directly adjacent to . . . ”, etc.).

Terms used herein are only intended to illustrate the detailed embodiments but not to limit the exemplary embodiments. The singular form “a” and “one” herein are to be construed to include the plural form, unless otherwise clearly indicated in the context. In addition, the terms “comprise” and/or “include” used herein define the presence of a characteristic, integer, step, operation, unit and/or means as defined, but are not intended to rule out the presence or addition of one or more other characteristics, integers, steps, operations, units, means and/or combinations thereof.

It is to be understood that a function/operation can be executed in accordance with a sequence different from that identified in a figure in some alternative embodiments. For example, it is determined by the involved function/operation that two diagrams shown in succession can be executed almost simultaneously or sometimes in reverse sequence in practice.

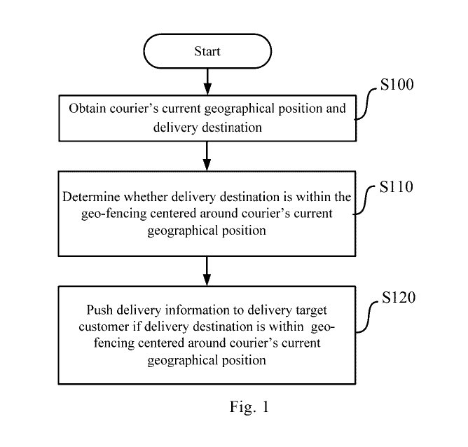

Please refer to FIG. 1, method 1 for automatically pushing delivery information in accordance with one embodiment of the application.

In method 1, the delivery information includes, but is not limited to, at least one of the following: a name of the item(s) to be delivered, an order number for the item(s) to be delivered, an amount of item(s) to be delivered, a current position of the item(s) to be delivered, and information including a contact number and a name of a courier corresponding to the item(s) to be delivered.

Delivery information is primarily aimed at identifying a target customer in the field of logistics distribution. The target customer can be a user placing an order for an item, or items, to be delivered to the user's location. For example, user A orders an air conditioner from an e-commerce platform and the e-commerce platform is instructed to arrange delivery of the air conditioner to user A's location. In this case, the target customer can refer to user A. Alternatively, the target customer can also refer to someone other than the user who places the order. For example, user B orders a bouquet of roses from an e-commerce platform, which are to be delivered to user C. In this case, the target customer refers to user C.

Method 1 for the automatically pushing delivery information can be executed by at least one of the following: a single computer, a plurality of computers, a single network server, a plurality of network servers and a cloud consisting of a plurality of computers or network servers configured to provide cloud computing.

With reference to S100 of FIG. 1, a courier's current geographical position and delivery destination are obtained. The courier includes, but is not limited to, a courier delivering items including parcels and letters, etc.

The courier's current geographical position can be composed of longitude and latitude and also specific location information. For example, the specific location information can be address number X, street X, District X, City X, which can be combined with longitude and latitude information.

The delivery destination can refer to a consignee's address. For example, a user orders an air-conditioner from an E-commerce platform and specifies a consignee's address as the delivery destination. The delivery destination can also refer to a collection location near the consignee's address set by E-commerce platform offline. For example, a user sets the collection location of a shop near the user's house in the user's community to be the delivery address in case the consignee is not at home.

The delivery destination can be stored on either a terminal (e.g. cell phone, tablet computer or other electronic device that can upload geographical position information) held by courier, or stored on a server (e.g. a server for automatically pushing delivery information), or both the terminal and server.

The courier's current geographic position can be obtained from a Global Positioning System (GPS) unit of the terminal (e.g. cell phone, tablet computer or other electronic device that can upload the geographical position information) held by the courier and uploaded automatically to the server (e.g. a server for automatically pushing delivery information). The terminal can also provide a current geographic location to the server in response to a request received by the terminal from a server, which automatically sends the request to the terminal held by courier to obtain courier's current geographical position.

Optionally, the courier's current geographical position is obtained regularly. For example, the terminal held by the courier regularly uploads the courier's current geographical position to a server (e.g. a server for automatically pushing delivery information).

Optionally, the courier's current geographical position is obtained in real-time. For example, the server (e.g. a server for automatically pushing delivery information) obtains, in real-time and automatically, the courier's current geographical position.

In S110, a determination is made whether the delivery destination is within a geo-fencing centered around the courier's current geographical position.

A geo-fencing can refer to a virtual geographic boundary surrounded by a virtual fence. That is, geo-fencing defines a virtual boundary, which can be used to demarcate whether a geographical position is within or outside the geo-fencing, or virtual geographic boundary. Optionally, when the terminal (e.g. cell phone, tablet computer or other electronic device that can upload geographical position information) held by a user enters or exits a certain geo-fencing or moves about within a certain geo-fencing, the terminal can receive a message notification and/or a reminder sent by a certain server (e.g. a server automatically pushing delivery information).

In an embodiment, in order to identify each courier's scope of action in time, or promptness of action, the geo-fencing, or area, which is created using the courier's current geographical position as its center. The geo-fencing in the embodiment moves with the courier's current geographical position.

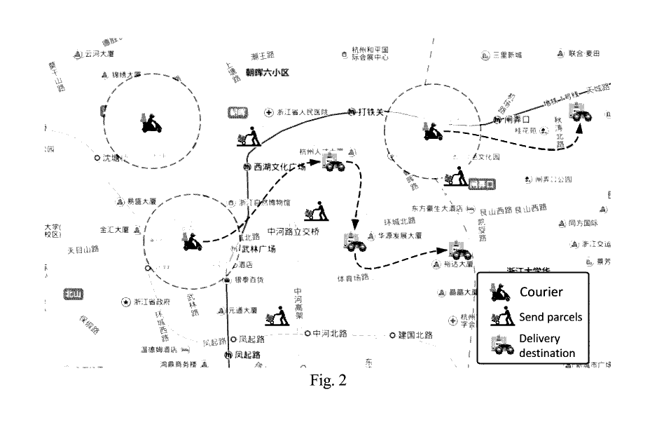

In order to demonstrate the geo-fencing used in connection with embodiments of the present application in more detail, reference is made to FIG. 2. In the example of FIG. 2, the geographic area of a geo-fencing is displayed, on the map, with dotted lines, each geo-fencing is determined using each courier's current geographical position as its center. In the example shown in FIG. 2, each geo-fencing moves with the respective courier, and uses the courier's current geographical position as its center. Courier's routes are displayed with dotted arrow in FIG. 2.

The scope of the geo-fencing can be set on the terminal by the courier in person or set by default by the server (e.g. a server for automatically pushing delivery information).

A geo-fencing with the courier's current geographical position as its center can be a circular shape or regular polygon with the courier's current geographical position as its center and have a specified distance as its radius. A geo-fencing can also be an irregular polygon with the courier's current geographical position as its center, with its boundaries being defined by geographic features, e.g., a natural boundary present in the topography such as forests and rivers, with respect to the real world, as may be seen in map images, for example.

Determining whether the delivery destination is within the geo-fencing centered around the courier's current geographical position can be performed by the terminal (e.g. cell phone, tablet computer and other electronic device that can upload the geographical position information) held by courier or by the server (e.g. a server for automatically pushing delivery information).

If the determination is performed by the terminal held by courier, the courier's current geographical position and delivery destination can be obtained by the GPS configured on the terminal. The determination whether the delivery destination is within the geo-fencing set using the courier's current geographical position as its center is made by a module or device having a determining function configured on the terminal. The results of the determination will be uploaded to the server (e.g. a server for automatically pushing delivery information) by the terminal.

If the determination is made by the server (e.g. a server for automatically pushing delivery information), the courier's current geographical position and delivery destination can be obtained by the server. The server can make a determination whether the delivery destination is within the geo-fencing determined using terminal's (held by courier) current geographical position as the geo-fencing's center.

The determination whether a delivery destination is within the geo-fencing, which is centered around the courier's current geographical position, can be performed regularly, e.g., at certain intervals, or in real-time.

In S120, delivery information is pushed to the delivery target customer if the delivery destination is within the geo-fencing centered around the courier's current geographical position.

If the server receives the uploaded determination results regarding whether the delivery destination is within the geo-fencing with courier's current geographical position as its center from the terminal held by courier, the server can determine whether to push the delivery information to the delivery target customer according to the received determination results.

As mentioned above, the target customer can be the user who personally places the order. For example, user A orders an air-conditioner from an E-commerce platform and the E-commerce platform is required to arrange for the delivery. In this case, the target customer can refer to user A; the target customer can also refer to someone other than the user who personally places the order, for example, user B orders a bouquet of roses for user C from an E-commerce platform, in this case, the target customer can refer to user C.

If the delivery destination is within the geo-fencing centered around the courier's current geographical position, the server pushes the delivery information to the delivery target customer.

The delivery information can include but is not limited to at least one of: the name of items to be delivered, order number of items to be delivered, amount of items to be delivered, current position of items to be delivered, and information including contact number and name of courier corresponding to the items to be delivered.

With a timely communication between the courier and the target customer, the courier can determine whether to continue with the delivery to the target customer according to the feedback from the target customer.

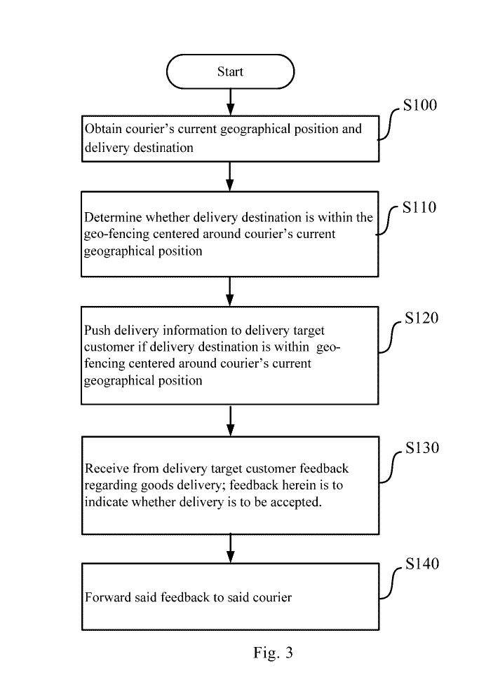

With reference to S130 of FIG. 3, feedback regarding the delivery information is received from the delivery target customer. The received feedback indicates whether the delivery can be accepted by the delivery target customer.

The server can push the delivery information to the delivery target customer and can also receive from the delivery target customer feedback regarding the delivery information, the feedback includes, but is not limited to, one of the following: agreeing to receive delivery, temporarily inconvenient for receiving delivery and convenient for receiving delivery during XX time period.

In S140, the feedback is forwarded to the courier.

If the server receives the feedback regarding the delivery information from the delivery target customer, the feedback can be transmitted to the courier so that the courier can determine whether to continue with the delivery in accordance with the feedback.

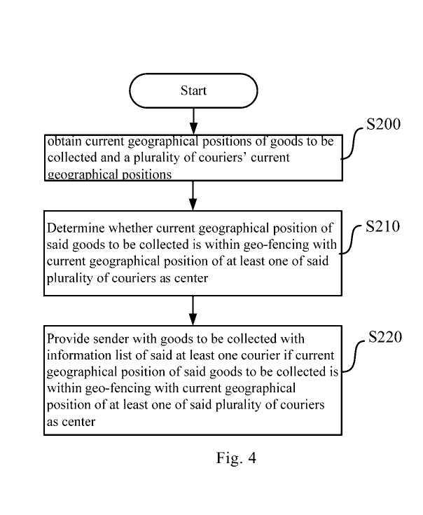

FIG. 4 illustrates a method to automatically provide collection information according to one disclosed embodiment.

In accordance with disclosed embodiments, collection information includes, but is not limited to, any one or more of contact number, name and current geographical position of the courier of items that are to be collected at the door and a time that the items are to be collected at the door.

The collection information in the embodiment is provided mainly for the sender of the items to be collected. For example and assuming that user A has a parcel for the courier to send to destination City X, user A is the sender of the items to be collected.

The method of automatically providing collection information can be executed by at least one of the following: a single computer, a plurality of computers, a single network server, a plurality of network servers and a cloud consisting of a plurality of computers or network servers configured to provide cloud computing.

In S200 of FIG. 4, the current geographical position of items to be collected and a plurality of couriers is obtained.

The item(s) to be collected herein can refer to such items as and without limitation parcel(s) and letter(s), etc. to be collected at the door by the courier.

The current geographical position of items to be collected can be composed of longitude and latitude information and also specific location information. For example, the specific location information can be No. X, Street X, District X, City X, and also a combination of longitude and latitude and specific location information.

In one example, a current geographical position of items to be collected can be input by the sender of the items to be collected on a terminal held by the sender and uploaded to the server to automatically provide collection information. For example, the current geographical position input can be No. X, Street X, District X, City X. In another example, the current geographical position of items to be collected can be identified on the terminal held by sender by the server to automatically provide collection information, and the identified geographical position will be provided for the sender to confirm without the sender manually inputting of the current geographical position information.

Optionally, the current geographical position of items to be collected is one of the sender's previously-used addresses of items to be collected or a new address other than the previously-used addresses. For example, a sender of the items to be collected usually sends items from company A through a courier, company A can become one of the previously-used addresses of the sender. For another example, a sender of the items to be collected moves from house B, which is one of the previously-used addresses, to new house C, from where the items need to be sent. In this case, house C is a new address other than a previously-used address.

The current geographical position of a plurality of couriers can be composed of longitude and latitude and also specific location information. For example, the specific location information can be No. X, Street X, District X, City X and also a combination of longitude and latitude and specific location information.

The current geographical position of a plurality of couriers can be obtained by a Global Positioning System (GPS) configured on terminal (e.g. cell phone, tablet computer and other electronic device that can upload the geographical position information) held by a courier. The current geographic position can be uploaded automatically to the server for automatically pushing delivery information. A courier's current geographical position can also be obtained by the server that automatically provides collection information; the server can send a request to obtain the courier's current geographical position and obtain the geographical position once the terminal accepts the request from the server.

Obtaining current geographical position of a plurality of couriers can be performed regularly or in real time.

By way of some non-limiting examples, a plurality of couriers can be all of the couriers of all delivery companies; or a specified courier, an unspecified courier or a plurality of couriers of one particular company or a plurality of specified companies selected by the sender of the items to be collected.

In accordance with an embodiment, a method to automatically provide collection information comprises receiving, from a sender of items to be collected, the plurality of couriers, wherein the plurality of couriers are selected from a courier group according to the selection requirements, or criteria, of couriers. The selection requirements, or criteria, for couriers, for example, include the specific delivery company of the courier, delivery speed tracking records, quality of delivery service and years of experience, etc.

Selecting a courier meeting the selection requirements, or selection criteria, specified by the item sender prior to determining a position based on a geo-fencing is beneficial for the server. The server's workload is reduced, as the server can avoid having to perform geo-fencing analysis for a plurality of couriers. Additionally, targeted collection service for an item sender is provided.

In S210 of FIG. 4, a determination is made whether the current geographical position of the items to be collected is within the geo-fencing of at least one of a plurality of couriers, each geo-fencing being determined using the current geographical position of a courier as its center.

A geo-fencing can be a circular shape or regular polygon with the current geographical position of at least one of the plurality of couriers as its center and with specified distance as radius. A geo-fencing can also be an irregular polygon with the current geographical position of at least one of the plurality of couriers as its center and limited by real-world geographic features, where the real world geographic features are according to map images.

The scope of the geo-fencing with the current geographical position of the at least one courier as its center can be personally set on the terminal by the courier or set by default by the server that automatically provides collection information.

Optionally, the server that automatically provides collection information determines whether the current geographical position of the items to be collected is within the geo-fencing of at least one of the plurality of couriers, the geo-fencing having a courier's current geographical position as its center.

The determination as to whether the current geographical position of the items to be collected is within the geo-fencing of at least one of the plurality of couriers can be performed regularly or in real time.

In S220, if the current geographical position of items to be collected is within the geo-fencing of at least one of the plurality of couriers, an informational list of the at least one courier is provided to the sender of the items to be collected, wherein the informational list includes the current geographical position of each of the at least one courier.

Optionally, the server that automatically provides collection information determines whether to provide the sender of the items to be collected with the informational list identifying at least one courier according to the results as to whether the current geographical position of items to be collected is within the geo-fencing of the at least one of the plurality of couriers. A courier's geo-fencing has the courier's current geographical position as its center.

For example, the server that automatically provides collection information determines whether the current geographical position of items to be collected is within the geo-fencing of each one of five courier's using the current geographical position of each one of five couriers as the center of the courier's respective geo-fencing. That is, the geo-fencing of the five couriers all overlap with the current geographical position of the items to be collected. Thus, the server that automatically provides collection information provides the sender of the items to be collected with the informational list of the five couriers, wherein the information list includes at least the current geographical position of each of the five couriers. Thus, the sender of the items to be collected can make a selection in accordance with the informational list of the five couriers provided by the server, and the sender can designate one or more couriers to collect the items to be collected at the door.

The informational list of the courier includes, but is not limited to, at least one of the following: information regarding the courier's current geographical position, the courier's name and contact number, the courier's delivery company, a record of delivering quality evaluations (including delivery speed and quality of service) of the courier, etc.

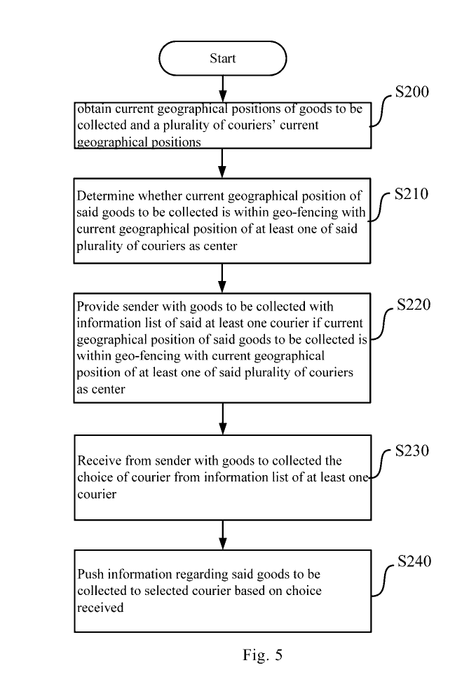

FIG. 5 provides a method to automatically provide collection information in accordance with at least one embodiment of the application. In accordance with the embodiment, the method determines which courier or couriers will provide collection service for the sender of specified items to be collected.

In S230 of FIG. 5, a sender's choice of at least one courier from the informational list is received from the sender of the items to be collected.

For example, the sender of the items to be collected can select one or more couriers as the provider to delivery items that are to be collected. The sender can make the selection from the informational list provided by the server that automatically provides collection information. Each of the at least one listed courier meets the selection requirements, or criteria, and has a geo-fencing overlapping with the current geographical position of items to be collected. Each courier's geo-fencing is determined using the courier's current geographical position as the center of the courier's geo-fencing.

In S240, information regarding the items to be collected is pushed to a selected courier based on the received choice. The information that is pushed to a selected courier identifies the items to be collected and the contact information of the sender of the items to be collected.

For example, the server that automatically provides collection information receives a choice of one or more specified couriers from the informational list from the sender of the items to be collected and pushes information regarding the items to be collected to the selected one or more specified couriers.

The information regarding the items to be collected includes, but is not limited to, at least one of the current geographical position of the items to be collected, contact information of the sender of the items to be collected, and the type, weight, volume and time for delivery of items to be collected, etc.

In some cases, there is no courier that currently meets the requirements, e.g., there is currently no courier that has a geo-fencing, as determined using the courier's current geographical position as the geo-fence's center, which overlaps with the current geographical position of items to be collected.

The embodiment shown in FIG. 5 takes into account the situation in which there is currently no courier that meets selection requirements, or criteria, in order to preferably provide more considerate service to the sender of the items to be collected.

In accordance with the embodiment shown in FIG. 5, if the current geographical position of items to be collected is outside the geo-fencing of each of the plurality of couriers, the sender of the items to be collected is queried whether the sender would like to continue waiting.

If a response is received from the sender of the items to be collected that the sender wishes to continue waiting, the current geographical positions of a plurality of couriers can be obtained and used to determine whether the current geographical position of items to be collected is within the geo-fencing of any of the plurality of couriers. The obtaining and determining can be operated regularly or in real time. Each courier's geo-fencing being determined using the current geographical position of the courier as the center of the courier's respective geo-fencing.

For example, at a current time, there is no courier with a geo-fencing, which is determined using the courier's current geographical position as the geo-fencing's center, which overlaps with the current geographical position of items to be collected. The server that automatically provides collection information can query the sender of the items to be collected whether the sender's would like to continue waiting. The display format of the query can be a prompt displayed on the terminal held by the sender of the items to be collected. For example, the prompt displayed on the terminal's interface can include a prompt asking the user “whether to wait for an alert from the server”.

If the server that automatically provides collection information receives a response from the sender that the sender is continuing to wait, the server, regularly or in real time, obtains the current geographical positions of a plurality of couriers and determines whether the current geographical position of items to be collected is within the geo-fencing of at least one of the plurality of couriers. The geo-fencing of each courier being determined using the courier's the current geographical position as the center of the geo-fencing. In so doing, the server can promptly inform the sender of the items to be collected, if a geo-fencing determined for at least one courier at some time in the future overlaps with the current geographical position of items to be collected.

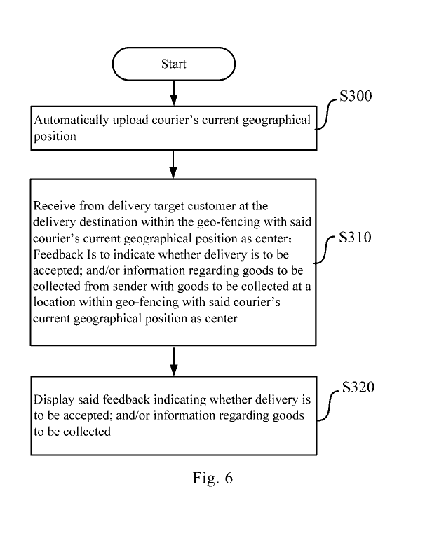

Reference is respectfully made to FIG. 6, which provides a third method for managing courier information in accordance with one embodiment of the application.

With respect to a delivery target customer located at a deliver destination within the geo-fencing centered around a courier's current geographic position, the courier information includes, but is not limited to, the delivery target customer's feedback indicating whether the delivery target customer is going to accept the delivery. The feedback including, but is not limited to, one of agreeing to receive delivery, an indication that delivery is temporarily inconvenient, and an indication that delivery would be convenient during XX time period, or other feedback.

With respect to a sender of items to be collected at a location within the geo-fencing centered around a courier's current geographical position, the courier information including, but is not limited to, one or more of information indicating the contact number, name and current geographical position of the courier that is to collect the items at the door, a time for items to be collected at the door, etc.

The third method can be performed by the terminal (e.g. cell phone, tablet computer and other electronic device that can upload the geographical position information) held by courier.

In S300 of FIG. 6, the courier's current geographical position is automatically uploaded.

The courier's current geographical position can be composed of longitude and latitude information and can further be composed of specific location information. For example, the specific location information can be No. X, Street X, District X, City X; and, the courier's current geographical position be a combination of the longitude and latitude information and the specific location information.

The information obtained in S300 can be obtained from a Global Positioning System (GPS) configured on the terminal (e.g. cell phone, tablet computer and other electronic device that can upload the geographical position information) held by the courier and uploaded automatically to a specified server.

In accordance with at least one embodiment, automatically upload of a courier's current geographical position can be performed at regular intervals or in real time.

In S310 of FIG. 6, feedback is received from the delivery target customer located at the delivery destination, which delivery destination is within the geo-fencing centered around the courier's current geographical position. The feedback indicating whether the delivery target customer is going to accept the delivery and/or the information regarding items to be collected from the sender of the items to be collected at a location within the geo-fencing centered around the courier's current geographical position.

The feedback and/or the information regarding items to be collected can be received from the specified server by the terminal held by courier.

In S320, the feedback indicating whether to accept the delivery and/or information regarding items to be collected is displayed.

Feedback and information regarding items to be collected can be displayed respectively according to a menu, e.g., a category menu. For example, the menu displayed on the terminal interface includes a menu item selectable to view feedback and a menu item selectable to view items to be collected. In response to the user's selection of the menu item to view feedback, the feedback is displayed on the terminal interface, or in response to selection of the menu item to view items to be collected, the items to be collected can be displayed.

Optionally, the geo-fencing used in method 3 can have a circular shape or a regular polygon with the current geographical position of the courier as its center and with a specified distance for a radius, and the geo-fencing can also have an irregular polygon with the current geographical position of the courier as its center and have boundaries determined by geographic features present in the real world, such as may be seen in map images, for example.

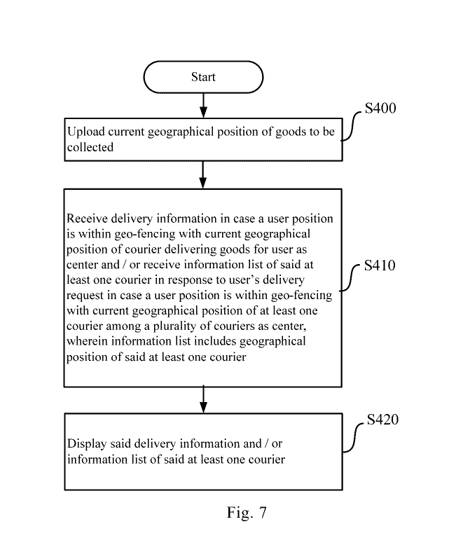

Reference is made to FIG. 7, which provides a fourth method of managing user information according to one embodiment of the present disclosure.

According to the embodiment and with respect to a user whose location is within a geo-fencing of a courier delivering items to the user, delivery information includes, but is not limited to, any one or more of the name of items to be delivered, order number of items to be delivered, amount of items to be delivered, current position of items to be delivered, and information including contact number and name of courier corresponding to items to be delivered. The courier's current geographical position is at the center of the courier's geo-fencing.

According to the embodiment and with respect to a user with items to be picked up by a courier, the user information comprises an informational list of at least one courier of a plurality of couriers with a geo-fencing that includes the user's position. The informational list includes the geographical position of the at least one courier and also at least one of information including name and contact number of the courier, delivery company of the courier, track record with an evaluation of delivering quality (including delivery speed and quality of service) of the courier, etc. The courier's geo-fencing has the courier's current geographical position as its center.

In accordance with the embodiment, the fourth method of managing user information can be performed by a terminal (e.g. cell phone, tablet computer and other electronic device that can upload the geographical position information) held by user.

In accordance with FIG. 7, in 5400, the current geographical position of items to be collected is uploaded.

The current geographical position of items to be collected can be input on the terminal by a sender of the items to be collected or obtained through the positioning module on the terminal and uploaded to specified server.

Optionally, the current geographical position of items to be collected can be an address previously used by the sender collecting items or a new address other than a previously-used address.

In S410, delivery information is received in a case that a user position is within the geo-fencing of a courier delivering items for the user at the user's position, and/or an informational list, which comprises a list of at least one courier, is received in response to the user's delivery request in a case that the user's position is within the geo-fencing of at least one courier among a plurality of couriers. The informational list includes the geographical position of the at least one courier. Each courier's current geographical position is used as the center of the geo-fencing used for the courier.

The delivery information and/or the informational list of the at least one courier can be obtained from the specified server by the terminal (e.g. cell phone, tablet computer and other electronic device that can upload the geographical position information) held by user.

In S420, the delivery information and/or informational list of the at least one courier is displayed.

The delivery information and informational list of the at least one courier can be displayed respectively according to a category menu. For example, the menu displayed on the terminal interface includes a delivery information menu selection and a courier information menu selection. In response to the user's selection of a delivery information menu selection, the terminal's interface displays the contents of the delivery information, and in response to the user's selection of the courier informational list menu selection, the terminal's interface displays contents of the courier informational list.

Optionally, the fourth method for managing user information also comprises receiving, from the user, feedback regarding the delivery information. The feedback received from the user indicating whether to accept the delivery, the feedback including, but is not limited to, one of the following: agreeing with pickup, temporarily inconvenient for pickup and convenient for pickup during XX time period and others.

The fourth method may optionally comprise uploading the feedback. The feedback can be uploaded to a specified server by a terminal (e.g. cell phone, tablet computer and other electronic device that can upload the geographical position information) held by user.

The feedback can optionally also indicate an acceptable time for delivery in a case that the user is rejecting a delivery.

Optionally, the fourth method for managing user information can also comprise receiving the user's choice of courier from the informational list of the at least one courier. The informational list of the courier(s) includes, but is not limited to, at least one of a delivery company of the courier, an evaluation of a courier's delivery track record, a courier's name and contact number, etc. The choice of a courier can comprise a courier, or a plurality of couriers, selected from the informational list of the at least one courier. The user's courier selection(s) can optionally be uploaded to a specified server by terminal (e.g. cell phone, tablet computer and other electronic device that can upload the geographical position information) held by user.

Optionally, the fourth method for managing user information also comprises displaying a query whether to continue waiting, if the user's position is outside the geo-fencing of any courier among a plurality of couriers. For example, a prompt asking “whether to wait for a reminder from the server” can be displayed on the terminal interface held by user. If a response is received from the user that the user wishes to continue waiting, the user's terminal can receive and display an informational list of at least one courier in a case that the user's position is thereafter within the geo-fencing of at least one courier of a plurality of couriers.

By responding to the user's choice to continue waiting for a reminder from the server, the embodiment can promptly display the courier's information for the user when a courier who meets the requirements, or criteria, is identified in the future, and can thus promptly arrange for item delivery.

Optionally, the fourth method for managing user information also comprises reminding the user to input the courier selection requirements, or criteria. The courier selection requirements, or criteria, can include, for example, a specified delivery company of the courier, a delivery speed track record, delivery service quality track record, years of experience, etc. The selection requirements, or criteria, input by the user can be received and uploaded, and the plurality of couriers can be selected from a courier group according to user's courier selection requirements, or criteria.

Therefore and in accordance with an embodiment, prior to carrying out the position determination based on the geo-fencing, the fourth method for managing user information selects one or more couriers meeting the selection requirements, or criteria, received from the item sender. Beneficially, this reduces a specified server's workload of analyzing the geo-fencing of a plurality of couriers on one hand and provides targeted collection service for an item sender on the other hand.

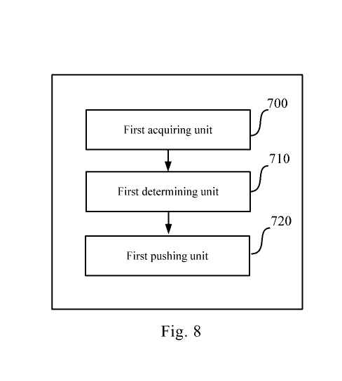

FIG. 8 provides a server for automatically pushing delivery information in accordance with at least one embodiment of the present disclosure. In the example shown in FIG. 8, the server comprises a first acquiring unit 700 configured to obtain a courier's current geographical position and delivery destination, a first determining unit 710 configured to determine whether the delivery destination is within the geo-fencing centered around the courier's current geographical position, and a first pushing unit 720 configured to push delivery information to the delivery target customer if the delivery destination is within the geo-fencing centered around the courier's current geographical position.

Optionally, the server also comprises a first receiving unit configured to receive, from a delivery target customer, feedback regarding the delivery information, the feedback indicates whether to receive the delivery. The server can optionally comprise a first forwarding unit configured to forward the feedback to the courier.

Optionally, the geo-fencing centered around the courier's current geographical position has a circular shape or is a regular polygon. The center of a courier's geo-fencing is a current geographical position of the courier, and the courier's geo-fencing has a specified distance as its radius.

In one embodiment, the first acquiring unit can be configured to regularly obtain a courier's current geographical position. The first determining unit can be configured to determine whether the delivery destination is within the geo-fencing, which is centered around the courier's current geographical position, which position is be regularly obtained.

In another embodiment, the first acquiring unit is configured to obtain a courier's current geographical position in real time. The first determining unit is configured to determine whether the delivery destination is within the geo-fencing centered around the courier's current geographical position, which is being obtained in real time.

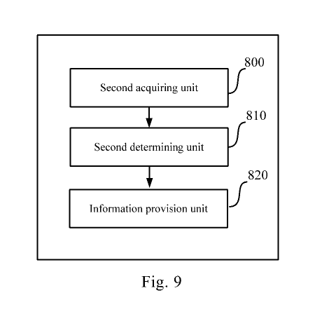

FIG. 9 provides an example of a server to automatically provide collection information in accordance with at least one embodiment of the present disclosure. As illustrated in FIG. 9, a server in accordance with at least one embodiment comprises a second acquiring unit 800, a second determining unity 810 and an in informational provision unit 820.

The second acquiring unit 800 obtains current geographical positions of items to be collected and a plurality of couriers, the second determining unit 810 is configured to determine whether the current geographical position of items to be collected is within a geo-fencing of at least one of the plurality of couriers. Each courier's geo-fencing uses the courier's current geographical position as its center. The server's information provision unit 820 is configured to provide the sender of the items to be collected with an informational list of at least one courier if the current geographical position of items to be collected is within the at least one courier's geo-fencing. Each courier of the at least one courier included in the informational list has a geo-fencing having the courier's current geographical position as its center. The informational list includes the current geographical position of each of the at least one the courier.

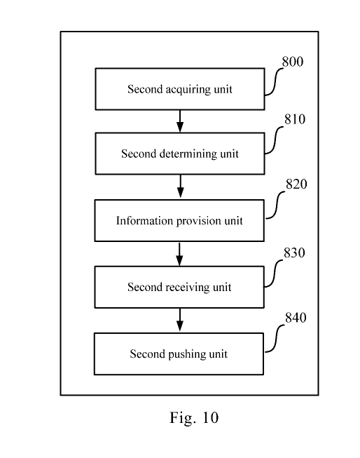

FIG. 10 provides optional components for use with the server shown in FIG. 9 in accordance with one or more embodiments of the present disclosure. As shown in FIG. 10 and in accordance with at least one embodiment, the server can further optionally comprise a second receiving unit 830 and a second pushing unit 840.

The second receiving unit 830 is configured to receive, from the sender of the items to be collected, a courier selected from the informational list of the at least one courier. The second pushing unit 840 is configured to push information about the items to be collected to the selected courier based on the choice received from the sender. The information about the items to be collected at least includes the current geographical position and contact information for the sender of the items to be collected.

Optionally, a geo-fencing can have a circular shape or regular polygon with the current geographical position of at least one of a plurality of couriers as its center.

In one embodiment, the second acquiring unit 800 is configured to regularly obtain current geographical positions of items to be collected and a geographical position of each of a plurality of couriers, and the second determining unit 810 is configured to regularly determine whether a current geographical position of the items to be collected is within a geo-fencing of at least one of the plurality of couriers.

In another embodiment, the second acquiring unit 800 is configured to obtain current geographical positions of items to be collected and the current geographical positions of a plurality of couriers in real time, and the second determining unit 810 is configured to determine, in real time, whether the current geographical position of the items to be collected is within the geo-fencing of at least one of the plurality of couriers. Each courier's geo-fencing using the courier's current geographical position as its center.

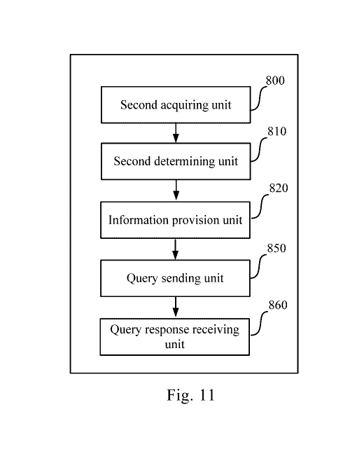

FIG. 11 provides optional components for use with the server shown in FIG. 9 in accordance with one or more embodiments of the present disclosure. As shown in FIG. 11 and in accordance with at least one embodiment, the server can further optionally comprise a query sending unit 850 and a query response receiving unit 860.

The query sending unit 850 is configured to send the sender of the items to be collected a query as to whether the sender wishes to continue waiting. The query can be sent to the sender if the current geographical position of items to be collected is outside the geo-fencing any one of the plurality of couriers. Each courier's geo-fencing using the courier's current geographical position as its center.

The query response receiving unit 860 is configured to receive a response from the sender of the items to be collected, the response indicating whether the sender would like to continue waiting.

In accordance with an embodiment of the present disclosure, the second acquiring unit 800 obtains, either regularly or in real time, the current geographical positions of a plurality of couriers in a case that the query response receiving unit 860 receives a response from the sender indicating that the sender would like to continue waiting.

When the query response receiving unit 860 receives a response from the send indicating that the sender would like to continue waiting, the second determining unit 810 determines, either regularly or in real time, whether the current geographical position of items to be collected is within the geo-fencing of at least one of the plurality of couriers. Each courier's geo-fencing using the courier's current geographical position as its center.

Optionally, the server further comprises a requirement receiving unit configured to receive, from the sender of the items to be collected, courier selection requirements, or criteria. The plurality of couriers is selected from a courier group according to the sender's courier selection requirements, or criteria.

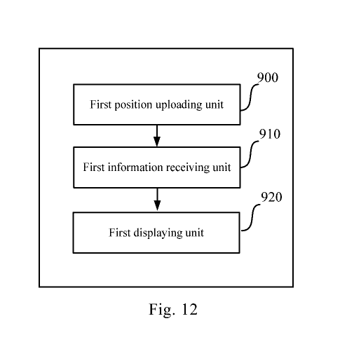

FIG. 12 provides an example of a terminal for managing courier information in accordance with at least one embodiment of the present disclosure.

In accordance with at least one embodiment, the terminal for managing courier information can be installed as an application, or an app, on electronic devices such as cell phone, tablet computer, etc. In accordance with an embodiments, the app is displayed as an app icon on electronic devices. In response to receiving a user's click on the app icon, the app is executed to provide functionality in accordance with one or more embodiments of the present disclosure.

As shown in the example of FIG. 12, the terminal for managing courier information comprises a first position uploading unit 900, a first information receiving unit 910 and a first displaying unit 920. The first position-uploading unit 900 is configured to automatically upload the courier's current geographical position. The first information receiving unit 910 is configured to receive, from the delivery target customer at the delivery destination within the geo-fencing centered around the courier's current geographical position, feedback indicating whether to accept the delivery and/or information regarding items to be collected from the sender of the items to be collected at a location within the geo-fencing centered around the courier's current geographical position.

The first displaying unit 920 is configured to display the feedback indicating whether to accept the delivery and/or the information regarding items to be collected.

Optionally, the geo-fencing centered around the courier's current geographical position has a circular shape or is a regular polygon with the current geographical position of the courier as its center and with a specified distance as a radius.

The first position-uploading unit 900 can be configured to automatically upload the courier's current geographical position regularly or in real time.

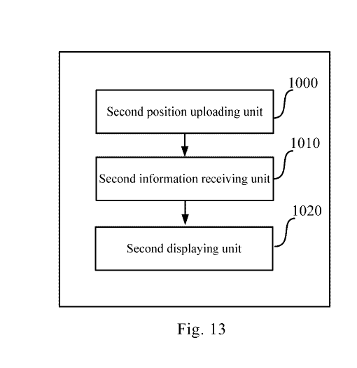

FIG. 13 provides an example of a terminal for managing user information in accordance with at least one embodiment of the present disclosure. The terminal for managing user information can be installed on electronic devices such as cell phone, tablet computer, etc. in an Application (app) form. The app can be displayed as an app icon on electronic devices. In response to receiving a user's click on the app icon, the app is executed to provide functionality in accordance with one or more embodiments of the present disclosure.

In accordance with FIG. 13, the terminal for managing user information comprises a second position uploading unit 1000, a second information receiving unit 1010 and a second displaying unit 1020.

The second position uploading unit 1000 is configured to upload the current geographical position of items to be collected. The second information receiving unit 1010 is configured to receive delivery information in case a user position is within the geo-fencing centered about the current geographical position of a courier delivering items for the user and/or to receive the informational list of the at least one courier in response to a user's delivery request in case a user position is within the geo-fencing centered about the current geographical position of at least one courier of a plurality of couriers. The informational list includes the geographical position of the at least one courier. The second displaying unit 1020 is configured to display the delivery information and/or the informational list of the at least one courier.

Optionally, the terminal for managing user information further comprises a feedback receiving unit configured to receive from the user the feedback regarding the delivery information, the feedback indicates whether to receive the delivery, and a feedback uploading unit configured to upload the feedback. The feedback also indicates an acceptable time for the delivery in a case that the user is rejecting the delivery.

Optionally, the terminal for managing user information further comprises a third receiving unit configured to receive from the user the choice of courier from information list of the at least one courier, and a third uploading unit configured to upload the choice.

Optionally, the terminal for managing user information further comprises a third displaying unit configured to display the query requesting the user to indicate whether the user wishes to continue waiting in a case that a user position is outside the geo-fencing of each courier of a plurality of couriers. The terminal optionally further comprises a fourth displaying unit configured to receive and display an informational list of at least one courier if a response is received from the user indicating that the user wishes to continue waiting and the user's position becomes within the geo-fencing of at least one courier of a plurality of couriers. Each courier's geo-fencing is centered about the courier's current geographical position.

Optionally, the terminal for managing user information further comprises a reminding unit configured to remind a user to input the courier selection requirements, or criteria, and a courier selection requirements uploading unit configured to receive and upload the courier selection requirements, or criteria, input by the user. A plurality of couriers can be selected from a courier group according to the user's courier selection requirements, or criteria.

It should be understood that the block diagrams provided in FIGS. 8-13 are only intended for illustration of embodiments disclosed herein and are not intended to limit the scope of the application. Some devices can be added or removed in some cases.

Those skilled in the art shall understand that the application can be utilized as a system, method or computer program product. Therefore, one or more of the embodiments disclosed herein can be implemented entirely using hardware, software or some combination of software and hardware.

The flow diagrams and block diagrams provided by the Drawings embody architecture, function and operation that can be implemented according to any of a system, method and computer program product in accordance with one or more embodiments of the application. In this regard, a block in the flow diagrams and block diagrams represents at least a part of a module, program segment or code, which includes one or more executable commands for performing a given logical function. It should be apparent that the function identified in a block diagram can be executed in accordance with a sequence different from that identified in the FIG. in some alternative embodiments. For example, a function may be implemented by two blocks shown in succession that can be executed almost simultaneously or sometimes in reverse sequence in practice. It also should be noted that every block in the block diagrams and/or flow diagrams and any combination of blocks in block diagrams and/or flow diagrams can be implemented by a specialized system executing a given function or operating in hardware or by a combination of specialized hardware and computer commands.

It should be apparent to those skilled in the art that the application is not limited to details of the above exemplary embodiments and can be specifically utilized by specific configurations without departing from the spirit and principles of the application. Therefore, the embodiments should be regarded as exemplary and unrestrictive. The scope of the application is specified by the appended Claims not by the above description. The application is aimed to include all expressions of the elements and equivalents within the scope of the Claims. Any symbols in the drawings for the Claims should not be the construed as a limitation to the involved Claims.

1. A method comprising:
receiving, by a server computing device and from a computing device of a user via an electronic communications network, the user's current geographical location based on a current geographical position of the user's computing device;
receiving, by the server computing device via the electronic communications network, a geographical location of a delivery destination;
determining, by the server computing device, whether the delivery destination's geographical location is within a geo-fenced area centered around the current geographical position of the user's computing device; and
pushing, by the server computing device and via the electronic communications network, delivery information to a delivery target customer's computing device if the delivery destination's geographic location is within the geo-fenced area centered around the current geographical position of the user's computing device.

2. The method of claim 1, further comprising:
receiving, by the server computing device and from the delivery target customer's computing device via the electronic communications network, feedback regarding the delivery information, the feedback indicating whether delivery is acceptable by the delivery target customer; and
forwarding, by the server computing device via the electronic communications network, the feedback for display on a display of the user's computing device.

3. The method of claim 1, the geo-fenced area centered around the current geographical position being one of a circular shape and a regular polygon with the current geographical position of the user's computing device as its center and having a specific distance as a radius.

4. The method of claim 1, receiving the current geographical position of the user's computing device and determining whether the delivery destination's geographical location is within the geo-fenced area centered around the current geographical position are performed at regular intervals.

5. The method of claim 1, receiving the current geographical position of the user's computing device and determining whether the delivery destination's geographical location is within the geo-fenced area centered around the current geographical position of the user's computing device are performed in real time.

6. A method comprising:
obtaining, by a server computing device and from a first user's computing device via an electronic communications network, a current geographical location of an item to be collected;
obtaining, by the server computing device and from a computing device of each of a plurality of second users via the electronic communications network, each second user's geographic location based on a current geographical position of the second user's computing device;
determining, by the server computing device and for each second user of the plurality, a geo-fenced area centered around the current geographical position of the second user's computing device;
determining, by the server computing device, whether the current geographical location of the item to be collected is within at least one second user's determined geo-fenced area; and
if the current geographical location of the item to be collected is within the geo-fenced area of at least one second user of the plurality of second users, providing, by the server computing device and to the first user's computing device via the electronic communications network, an informational list identifying the at least one second user, the informational list comprising the current geographical position of each of the at least one second user's computing device.

7. The method of claim 6, further comprising:
receiving, by the computing device and from the first user's computing device via the electronic communications network, input indicative of a choice of a selected second user, the selected second user being selected from the informational list identifying the at least one second user; and
pushing, by the server computing device and via the electronic communications network to the selected second user's computing device, information regarding the item to be collected, the information regarding the item to be collected comprising a current geographical location of the item to be collected and contact information of the first user.

8. The method of claim 6, each second user's determined geo-fenced area being one of a circular shape and a regular polygon with the current geographical position of the second user's computing device as its center and having a specific distance for a radius.

9. The method of claim 6, obtaining the current geographical position of each second user's computing device and determining whether the item to be collected is within the at least one second user's determined geo-fenced area are performed at regular intervals.

10. The method of claim 6, obtaining the current geographical position of each second user's computing device and determining whether the item to be collected is within the at least one courier's determined geo-fenced area are performed in real time.

11. The method of claim 6, further comprising:
if the current geographical location of the item to be collected is not within the at least one second user's determined geo-fenced area, sending, by server computing device via the electronic communications network to the first user's computing device via the electronic communications network, a query requesting input from the first user indicating whether the first user wishes to continue waiting;
the obtaining the current geographical position of each second user's computing device and the determining whether the item to be collected is within the at least one second user's determined geo-fenced area are conditional upon receiving a response, from the first user's computing device that the first user wishes; to continue waiting.

12. The method of claim 6, further comprising:
receiving, by the server computing device and from the first user's computing device via the electronic communications network, at least one requirement for selection of the plurality of second users;
selecting, by the server computing device, the plurality of second users from a second user set in accordance with the at least one received requirement for selection.

13. A method comprising:
obtaining, by a first user's computing device using a positioning component of the computing device, a current geographic position of the first user's computing device;
automatically uploading, by the first user's computing device via an electronic communications network, the current geographical position of the first user's computing device as the geographic location of the first user;
in a case that an item is to be collected:
receiving, by the first user's computing device and via an electronic communications network, information regarding the item to be collected in a case that the item to be collected is at a geographic location within a geo-fenced area centered around the first user's current geographical position; and
displaying, by the first user's computing device, the received information regarding the item to be collected;
in a case that an item is to be delivered:
receiving, by the first user's computing device and via an electronic communications network, information comprising feedback indicating whether delivery is acceptable by a second user in a case that a delivery destination's geographic location for the item to be delivered is within the geo-fenced area centered around the first user's current geographical position; and
displaying, by the first user's computing device, the received information comprising feedback indicating whether delivery is acceptable.

14. The method of claim 13, the geo-fenced area centered around the current geographical position of the first user's computing device being one of a circular shape and a regular polygon with the current geographical position of the first user's computing device as its center and having a specific distance for a radius.

15. The method of claim 13, the current geographical position of the first user's computing device is automatically updated one of periodically and in real time.

16. A method comprising:
in a case that an item to be collected:
uploading, by the first user's computing device and via an electronic communications network, a geographic location of the item to be collected;
receiving, by the first user's computing device and via the electronic communications network, an informational list identifying at least one second user of a plurality of second users in a case that the geographic location of the item to be collected is within a geo-fenced area of the at least one second user, the geo-fenced area for each second user being based on a geographic position of a computing device of the second user, the informational list includes the geographical position of each of the at least one second user; and
displaying, by the first user's computing device, the informational list;
in a case that an item is to be delivered:
receiving, by the first user's computing device and via the electronic communications network, delivery information in a case that a delivery destination's geographic location for the item's delivery destination is within a geo-fenced area centered around a current geographical position of a computing device of a second user that is to deliver the item; and
displaying, by the first user's computing device, the received delivery information.

17. The method of claim 16, further comprising:
receiving, by the first user's computing device and from the first user, feedback regarding the delivery information, the feedback indicating whether the delivery of the item is acceptable to the first user; and
uploading, by the first user's computing device and via the electronic communications network, the received feedback.

18. The method of claim 17, the received feedback comprising an alternate time for the delivery of the item in a case that a scheduled time of delivery is unacceptable to the first user.

19. The method of claim 16, further comprising:
receiving, by the first user's computing device and from the first user, input indicative of a selection, by the first user, of a second user selected from the received informational list; and
uploading, by the first user's computing device and via the electronic communications network, the first user's selection.

20. The method of claim 16, further comprising:
displaying, by the first user's computing device, a query requesting input from the first user whether to continue waiting if the geographic location of the item to be collected is not within the geo-fenced area of at least one second user; and
if a response is received, by the first user's computing device from the first user, indicating that the first user wishes to continue waiting, the first user's computing device, receiving and displaying the informational list identifying the at least one second user in a case that it is determined that the geographic location of the item to be collected comes to be within the geo-fenced area at least one second user.

21. The method of claim 16 further comprising:
displaying, by the first user's computing device, a prompt for the first user to input at least one requirement for use in a second user selection operation;
receiving, by the first user's computing device, the first user's input comprising the at least one requirement for the second user selection operation;
uploading, by the first user's computing device and via the electronic communications network, the first user's input comprising the at least one requirement for use in the second user selection operation, the plurality of second users to be selected from a set of second users in accordance with the at least one received requirement for use in the second user selection operation.

22. A server comprising:
a processor;
a non-transitory computer-readable storage medium for tangibly storing thereon program logic for execution by the processor, the program logic comprising:
acquiring logic executed by the processor for acquiring, via an electronic communications network and from a computing device of a user, the user's current geographical location based on a current geographical position of the user's computing device and acquiring, via the electronic communications network, a geographic location of a delivery destination;
determining logic executed by the processor for determining whether the delivery destination's geographic location is within a geo-fenced area centered around the current geographical position of the user's computing device; and
pushing logic executed by the processor for pushing, via an electronic communications network, delivery information to a delivery target customer's computing device if the delivery destination's geographic location is within the geo-fenced area centered around the current geographical position of the user's computing device.

23. The server of claim 22, the stored program logic further comprising:
receiving logic executed by the processor for receiving, from the delivery target customer's computing device via the electronic communications network, feedback regarding the delivery information; the feedback indicating whether delivery is acceptable by the delivery target customer; and
forwarding logic executed by the processor for forwarding the feedback to the user's computing device via the electronic communications network.

24. The server of claim 22, the geo-fenced area centered around the current geographical position the user's computing device being one of a circular shape and a regular polygon with the current geographical position of the user's computing device as its center and having a specific distance as a radius.

25. The server of claim 22:
the acquiring logic executed by the processor for acquiring periodically obtaining the current geographical position of the user's computing device;
and the determining logic executed by the processor for determining periodically determining whether the delivery destination's geographic location is within the geo-fenced area centered around the current geographical position of the user's computing device.

26. The server of claim 22:
the acquiring logic executed by the processor for acquiring obtaining the current geographical position of the user's computing device in real time; and
the determining logic executed by the processor for determining whether the delivery destination's geographic location is within the geo-fencing centered around the current geographical position of the user's computing device in real time.

27. A server comprising:
a processor;
a non-transitory computer-readable storage medium for tangibly storing thereon program logic for execution by the processor, the program logic comprising:
acquiring logic executed by the processor for acquiring, from a first user's computing device via an electronic communications network, a current geographical location of an item to be collected and acquiring, via the electronic communications network and from a computing device of each of a plurality of second users, a current geographical position of each second user's computing device;
determining logic executed by the processor for determining, for each second user of the plurality, whether the current geographical location of the item to be collected is within a geo-fenced area of at least one second user, each second user's geo-fenced area being centered around the current geographical position of the second user's computing device; and
providing logic executed by the processor for providing, via the electronic communications network and to a computing device of a first user with an informational list identifying the at least one second user if the current geographical position of the item to be collected is within the at least one second user's geo-fenced area, the informational list comprising the current geographical position of the computing device of each of the at least one second user.

28. The server of claim 27, the stored program logic further comprising:
receiving logic executed by the processor for receiving, from the first user's computing device and via the electronic communications network, input indicative of a choice of a selected second user, the selected second user being selected from the informational list identifying the at least one second user; and
pushing logic executed by the processor for pushing, to the second user's computing device, information regarding the item to be collected, the information regarding the item to be collected comprising a current geographical location of the item to be collected and contact information of the first user.

29. The server of claim 27, each second user's determined geo-fenced area being one of a circular shape and a regular polygon with the current geographical position of the second user's computing device as its center and having a specific distance for a radius.

30. The server according to claim 27:
the acquiring logic executed by the processor for acquiring periodically obtaining the current geographical location of the item to be collected and the current geographical position of the computing device of each second user of the plurality of second users; and
the determining logic executed by the processor for determining periodically determining whether the current geographical location of the item to be collected is within the geo-fenced area of at least one second user.

31. The server of claim 27:
the acquiring logic executed by the processor for acquiring obtaining the current geographical location of the item to be collected and the current geographical position of the computing device of each second user of the plurality of second users in real time; and
the determining logic executed by the processor for determining whether the current geographical location of the item to be collected is within the geo-fenced area of the at least one second user in real time.

32. The server of claim 27, the stored program logic further comprising:
sending logic executed by the processor for sending a query to the first user's computing device via the electronic communications network, the query requesting input from the first user indicating whether the first user wishes to continue waiting if the current geographical location of the item to be collected is not within the geo-fenced area of at least one second user;
receiving logic executed by the processor for receiving, from the first user's computing device via the electronic communications network, a response indicating whether the first user wishes to continue waiting;
the acquiring logic executed by the processor for acquiring the current geographical location of the item to be collected and the acquiring logic executed by the processor for acquiring the current geographical position of the computing device of each second user of the plurality of second users are conditional on the first user's response indicating that the first user's wishes to continue waiting; and
the determining logic executed by the processor for determining whether the current geographical location of the item to be collected is within the at least one second user's geo-fenced area is conditional on the first user's response indicating the first user's wishes to continue waiting.

33. The server of claim 27, stored program logic further comprising:
receiving logic executed by the processor for receiving, from the first user's computing device via the electronic communications network, a requirement for use in a second user selection operation, the plurality of second users to be selected from a second user set in accordance with the received requirement.

34. A terminal comprising:
a positioning component;
a processor;
a non-transitory computer-readable storage medium for tangibly storing thereon program logic for execution by the processor, the program logic comprising:
uploading logic executed by the processor for automatically uploading, via an electronic communications network, the current geographical position of the terminal determined using the positioning component;
in a case that an item is to be collected:
receiving logic executed by the processor for receiving, via an electronic communications network, information regarding the item to be collected in a case that the item to be collected is at a geographic location within a geo-fenced area centered around the current geographical position of the terminal; and
display logic executed by the processor for displaying the received information regarding the item to be collected;
in a case that an item is to be delivered:
receiving logic executed by the processor for receiving, via an electronic communications network, information comprising feedback indicating whether delivery is acceptable by a user in a case that a delivery destination's geographic location for the item to be delivered is within the geo-fenced area centered around the current geographical position of the terminal; and
displaying logic executed by the processor for displaying the received information comprising feedback indicating whether delivery is acceptable.

35. The terminal of claim 35, the geo-fenced area centered around the current geographical position of the terminal being one of a circular shape and a regular polygon with the current geographical position of the terminal as its center and having a specific distance for a radius.

36. The terminal of claim 35, the current geographical position of the terminal is automatically updated one of periodically and in real time.

37. A terminal, comprising:
a processor;
a non-transitory computer-readable storage medium for tangibly storing thereon program logic for execution by the processor, the program logic comprising:
in a case that an item is to be collected:
uploading logic executed by the processor for uploading, via an electronic communications network, a geographic location of the item to be collected;
receiving logic executed by the processor for receiving, via an electronic communications network, an informational list identifying at least one second user of a plurality of second users in a case that the geographic location of the item to be collected is within a geo-fenced area of the at least one second user, the informational list includes the geographical position of each of the at least one second user; and
displaying logic executed by the processor for displaying the received informational list;
in a case that an item is to be delivered:
receiving logic executed by the processor for receiving, via the electronic communications network, delivery information in a case that a delivery destination's geographic location for the item to be delivered is within a geo-fenced area centered around a current geographical position of a computing device of a second user that is to deliver the item; and
displaying logic executed by the processor for displaying the received delivery information.

38. The terminal of claim 38, the stored program logic further comprising:
receiving logic executed by the processor for receiving, from the first user, feedback regarding the delivery information, the feedback indicating whether the delivery of the item is acceptable to the user; and
uploading logic executed by the processor for uploading, via the electronic communications network, the received feedback.

39. The terminal of claim 39, the received feedback comprising an alternate time for the delivery of the item in a case that a scheduled time of delivery is unacceptable to the first user.

40. The terminal of claim 38, the stored program logic further comprising:
receiving logic executed by the processor for receiving, from the first user, input indicative of a selection, by the first user, of a second user selected from the received informational list; and
uploading logic executed by the processor for uploading the received choice via the electronic communications network.

41. The terminal of claim 38, the stored program logic further comprising:
displaying logic executed by the processor for displaying a query requesting input from the first user whether the first user wishes to continue waiting if the geographic location of the item to be collected is not within the geo-fenced area of at least one second user; and
if a response is received from the first user indicating that the first user wishes to continue waiting, the receiving and displaying logic executed by the processor for receiving and displaying the informational list of the at least one second user in a case that it is determined that the geographic location of the item to be collected comes to be within the geo-fenced area of at least one second user.

42. The terminal of claim 38, the stored program logic further comprising:
displaying logic executed by the processor for displaying a prompt for prompting the first user to input at least one requirement for use in a second user selection operation; and
logic executed by the processor for receiving, from the first user, and uploading, via the electronic communications network, the first user's input comprising the at least one requirement for use in the selection operation, the plurality of second users to be selected from a set second users in accordance with the at least one received requirement for use in the selection operation.
